(19) United States
(12) Patent Application Publication
(10) Pub. No.: US 2024/0346778 A1
(43) Pub. Date: Oct. 17, 2024

(54) Augmented Reality Applications

(71) Applicant: Mark W. Fuller, Sun Valley, CA (US)

(72) Inventor: Mark W. Fuller, Sun Valley, CA (US)

(21) Appl. No.: 18/607,399

(22) Filed: Mar. 15, 2024

Related U.S. Application Data
(60) Provisional application No. 63/452,634, filed on Mar. 16, 2023.

(51) Int. Cl. G06T 19/00; G06K 7/10; G06K 7/14; G06T 13/60; G06V 20/20

(52) U.S. Cl. CPC G06T 19/006; G06K 7/10722; G06K 7/1417; G06T 13/60; G06V 20/20; G06T 2200/24

(57) ABSTRACT

A system for presenting augmented reality information with respect to one or more articles of apparel is presented. The article of apparel may include at least one graphical image embedded with at least one augmented reality marker. The graphical image may include an image of a water fountain display, and the system may overlay augmented images of water display elements onto the graphic. The system also includes a tool for developing said water display graphics and associated augmented reality markers.

### CROSS REFERENCE TO RELATED APPLICATION

This application claims the benefit of U.S. Provisional Application No. 63/452,634, filed Mar. 16, 2023, the contents of which are incorporated herein by reference.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

The field of the invention generally relates to augmented reality, including augmented reality content delivered in association with apparel, and the visualization of water fountain displays.

### BACKGROUND

Augmented reality (AR) generally includes technology that superimposes computer-generated imagery (virtual images) onto a user's view of the real world as seen on the display of a smartphone, tablet computer, or other type of electronic device. To experience augmented reality, a user typically view's his/her surroundings on the camera display of a smartphone and the AR software places the virtual images within the camera's view. In this way, the superimposed virtual images appear alongside the real images that the user experiences.

In addition, “AR markers” may be placed in the real world and used by the AR software to place the virtual images within the display. For example, an AR marker may include a physical object and/or a distinct pattern (e.g., a symbol) visually independent of the environment such that the marker may be easily recognizable by the software. Once recognized, the software may use the marker as a guide as to what virtual content to overlay the image and where. The virtual content may include still images, animations, videos, characters, animals, audio, and other types of virtual content.

However, AR is not currently used in connection with apparel nor in connection with visualizing water fountain displays based on a drawing. Accordingly, there is a need for AR systems for these applications.

### SUMMARY OF THE INVENTION

The present invention is specified in the claims as well as in the description.

A first aspect of the invention regards an augmented reality system that is applied for use with clothing apparel, whereby a pattern or other visual representation is printed or otherwise applied to the apparel, the representation is recognized by a viewing device loaded with the appropriate augmented reality software, and the viewing device displays an enhanced or augmented image, e.g., a picture and/or video which combines the representation and a visual effect added thereto.

For example, in an embodiment of the invention involving the augmented display of water fountains, a pattern may be printed on wearable apparel, such as a T-shirt or baseball cap, and a viewer may aim his or her viewing device, such as a smartphone or tablet computer containing the appropriate augmented reality app or software, at the apparel. The smartphone or other viewing device may then display an image where a water fountain is performing on the person wearing the T-shirt. In the case of the baseball cap, the viewer may see a fountain sprouting from the top of the cap on the wearer's head.

In another aspect of the invention, because smartphone and tablet computers can sense ambient light level and judge whether it is day or night, such fountains may appear as daylight fountains during the day and colored or illuminated water fountains at night.

Another aspect of the invention involves the app or software that may be used to augment or enhance the representation shown on the wearable apparel.

In another aspect of the invention, audible sounds also may be provided by the viewing device equipped with the augmented reality app. For example, in the above example, the smartphone also may provide the sound of a gushing fountain.

Other aspects of the invention may involve other combinations of images, patterns or representations that are recognized by an AR-equipped viewing device to provide augmented or enhanced visual effects. For example, a child may be wearing a shirt with a zebra, and when the device is pointed at the shirt, the device may display the zebra in an animated form, e.g., coming to life.

In another aspect of the invention, a smartphone or other AR-equipped viewing device may bring drawings to life. That is, plan drawings or engineering drawings may include representations or markers that are recognized by the smartphone or other AR-equipped viewing device. In this embodiment, the drawing may be a plan drawing of a water fountain display that depicts the layout of the water delivery devices, lighting and other components comprising the water display. The plan drawing also may include representations or markers located at the components, where each representation or marker is tailored to the type of component with which it is associated in the plan drawing.

When the viewing device is pointed at the plan drawing, the device recognizes the representations or markers and uses this information to display the components as they would appear in real life when the water display is operating. For example, a water delivery device, such as a SHOOTER® nozzle, may be depicted in the plan drawing and may include a representation or marker that is recognized by the AR-equipped viewing device to display a computer-generated SHOOTER® nozzle emitting a stream of water.

As another example, the plan drawing may depict LED lights of various colors, and each of those LED lights may include a marker that is recognized by the AR-equipped viewing device as being an LED light of the desired color. Upon recognizing these markers, the AR-equipped viewing device may display computer generated LED lights as they would appear in the display in operation.

As another example of a plan drawing or other type of drawing depicting components along with specific patterns or markers, a viewing device with the requisite software may be aimed at this plan drawing, and an associated computer may generate a 3-D animation of the fountain jets actually spraying water. The system may then superimpose this image to generate the composite augmented image. With appropriate software, the computer also can ascertain from the pattern the angle from which the plan is being viewed and modify the 3D animation as though it were being seen from that same angle. In this way, when a user may move his/her viewing device over and around the plan drawing of the fountain, the viewer may see the fountain presented in 3D, with proper distance and perspective, as though he/she were flying over the fountain.

In another aspect, the system includes a tool for developing graphical images for use with AR implementations. The tool includes a graphical editor, a library of AR markers, and drag-and-drop functionality of the AR markers onto the graphical image.

Other aspects of the invention are described below.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 depicts aspects of an augmented reality system according to exemplary embodiments hereof;

FIGS. 2-3 show apparel items, e.g., a T-shirt and cap, that may be used with the augmented reality system of the current invention;

FIG. 4 depicts aspects of a graphic image according to exemplary embodiments hereof; and

FIG. 5 depicts aspects of virtual augmented reality information overlaid on the graphic image of FIG. 4 according to exemplary embodiments hereof;

FIG. 6 depicts aspects of a development tool according to exemplary embodiments hereof; and

FIG. 7 depicts aspects of computing according to exemplary embodiments hereof.

### DETAILED DESCRIPTION OF THE PREFERRED EMBODIMENTS

Preferred or exemplary embodiments of the invention are now described with reference to the figures. These preferred embodiments and examples are provided to provide further understanding of the invention, without limiting its scope. Alternate embodiments and variations of the subject matter described herein will be apparent to those of ordinary skill in the art.

In general, a system according to current invention provides for the creation and delivery of one or more visual experiences. In some embodiments, the visual experiences may include augmented reality (AR) experiences and implementations. In some embodiments, the visual experiences may correspond to and possibly be triggered by graphical images, e.g., graphical images imprinted on wearable apparel such as shirts, hats, and other types of apparel and/or accessories.

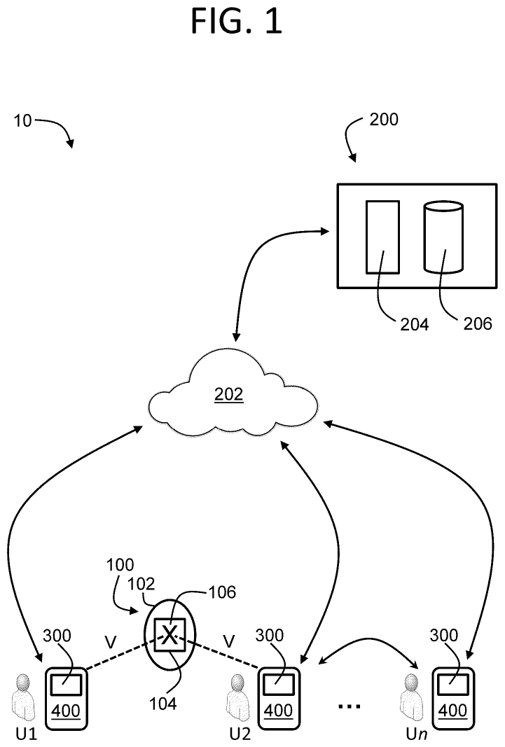

Referring now to FIGS. 1-7, the system 10 according to exemplary embodiments hereof is now described in further detail.

FIG. 1 shows an overview of an exemplary framework for an augmented reality (AR) system 10. As shown, the augmented reality system 10 (also referred to herein as simply the system 10) may include a real world (RW) object 100 and a backend system 200. The system 10 may be accessed by multiple users U1, U2, . . . Un (e.g., via the network 202) using an AR application 300 (e.g., a mobile application or “app”, a browser, or other types of applications) running on one or more computing devices 400 (e.g., smart phones, tablet computers, laptops, desktop computers, mobile media players, AR glasses, VR and/or AR headsets, etc.).

In some embodiments, the backend system 200 (which may comprise a cloud platform) may include one or more servers, one or more processors, memory, software, firmware, operating systems, a location determining application (e.g., GPS), and other components and elements that may be necessary for the backend platform 200 to perform functions such as those described herein. The backend system 200 also may include one or more applications 204 that may interface with one or more databases 206.

In some embodiments, the RW object 100 may include a base graphic 104 and optionally, an AR marker 106. Upon viewing the base graphic 104 with an AR viewing device 400 (as depicted by the dashed lines V in FIG. 1), the system 10 may detect the AR marker 106 and be triggered to overlay predefined virtual AR information onto the base graphic 104. The user Un may then view the RW object 100, the base graphic 104, and the overlaid virtual AR information through the display on the device 400.

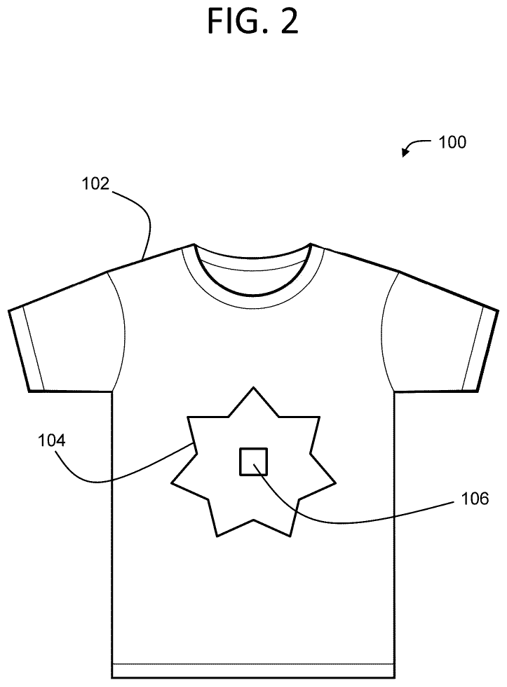

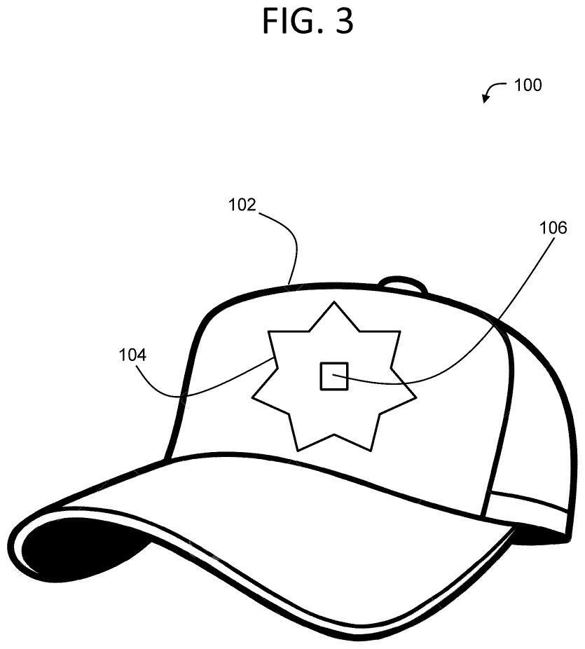

In some embodiments as shown in FIGS. 2 and 3, the RW object may include an article of clothing 102 (e.g., a shirt, hat, etc.) imprinted with the base graphic 104 (represented as a star for demonstration), and a marker 106 (represented by the inner square for demonstration). In a first example, the base graphic 104 may depict a water fountain and/or a water display comprising fountains and other components, and the AR marker 106 may be programmed to trigger the AR software to overlay virtual images of water streams. Accordingly, when the AR-equipped viewing device 400 is pointed at the base graphic 104, the smartphone 400 may recognize the marker 106 with respect to the base graphic 104 and overlay a virtual animation of water streams emitting from the water fountain graphic on the wearer's shirt.

In the embodiment of FIG. 3, the base graphic 104 on the hat 102 may again depict a water fountain and the AR marker 106 may be similarly programmed. Accordingly, when the AR-equipped viewing device 400 is pointed at the hat 102, the device 400 may recognizes the marker 106 with respect to the base graphic 104 and overlay a virtual animation of water streams emitting from the fountain, e.g., sprouting from the wearer's head.

As noted above, the current invention is not limited to only water fountains, water displays and/or the components that may comprise a water display. Instead, any image/pattern combination could be used on any type of apparel. For example, a child may wear a shirt where the base graphic 104 depicts a zebra, and the marker 106 may be programmed to trigger the AR software to provide complementary wildlife animations. Accordingly, when the zebra and its corresponding AR marker 106 are viewed by the viewing device 400, the system 10 may overlay virtual images (e.g., butterflies, the texture of the zebra's fur, etc.) onto the zebra 104 thereby bringing the graphic to life.

In addition, the current invention is not limited to the examples of T-shirts and caps, and it is understood that other types of apparel also may include base graphics 104 and markers 106. The current invention also is not limited to just apparel, e.g., a child's blanket may include base graphics 104 and markers 106 that provide an enhanced and/or augmented image on a viewing device 400.

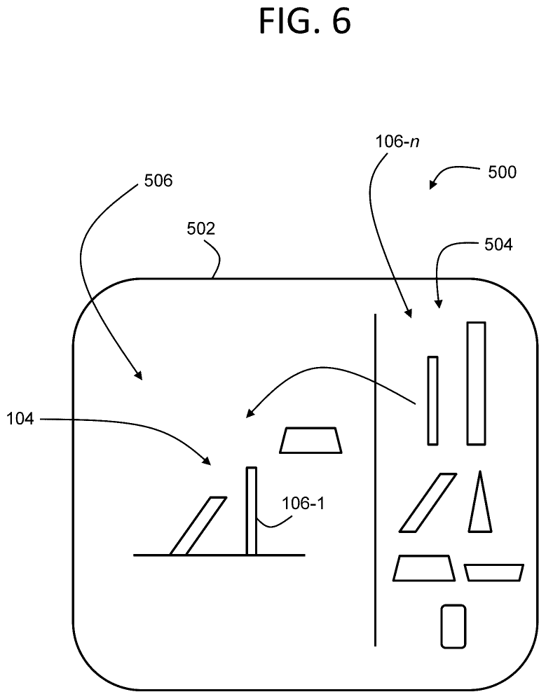

In other embodiments as described in other sections, e.g., with reference to FIG. 6, the system 10 also may include a tool 500 that may be used to create base graphics 104. The tool 500 may include a library of AR markers 106 and a graphical user interface (GUI) to facilitate the placement of the markers 106 onto desired base graphics 104 to create unique AR experiences.

The aforementioned will be described in further detail in other sections, but first, to facilitate a better understanding of the system 10, an overview of some general concepts of augmented reality (AR) is presented below.

Augmented reality (AR) generally relates to the integration of digital information with a user's natural environment in real time. Live real-time views of a real-world environment with real world objects may be “augmented” with digital sensory inputs such as animation, video, audio, graphics (still and/or moving), text, haptics, GPS data, and other types of elements. The viewing of the augmented environment may be direct or indirect and may include the use of a digital AR viewing device such as a computing device 400 or other types of suitable AR viewing devices running an AR app 300 that provides AR viewing.

An AR viewing device (e.g., device 400) preferably includes one or more cameras, one or more displays, GPS or other location determining functionality, and AR processing software or applications. Network connectivity (e.g., Internet connectivity) also may be required for the devices 400. In addition to the AR application 300, it may be preferable that the devices 400 also include applications that allow each device 400 to interface with the backend system 200. In this way, the devices 400 may send information (e.g., scanned AR markers, GPS data, etc.) to the backend platform 200 and receive virtual AR information (e.g., virtual images) from the backend platform 200 for implementation.

During use, the user may position the AR viewing device 400 so that the device's camera captures and displays a view of the user's environment (e.g., in video and/or still image mode) in real time on the display of the device 400. Generally speaking, the AR software may then augment the view by superimposing virtual images that may generally appear to be native elements of the environment.

There are multiple types of augmented reality (AR), including but not limited to:

1. Superimposition Based AR: Superimposition based augmented reality may partially or fully replace the original view of an environment with a newly augmented view of that same environment. A user may use an AR viewing device 400 to view the superimposed AR environments. For example, the user may engage the camera on a smartphone 400 to view the environment in front of him/her, and the AR app may superimpose digital images (also referred to as computer generated (CG) overlays or virtual objects) into the view. In this way, the superimposed images may appear to actually exist in the environment. The digital images may include animations, videos, graphics (still and/or moving), illustrations, objects, sounds, text, characters, other types of imagery, and any combination thereof.

Object detection/recognition technology is employed to trigger the AR implementations (often with the use of special images known as markers 106) and to determine the predefined two-dimensional and/or three-dimensional virtual AR information to be added to the view.

2. Markerless AR: Markerless AR (also referred to as location-based AR, position-based AR, or GPS AR), may use a GPS application, a digital compass, a velocity meter, an accelerometer, or other component embedded in an AR viewing device 400 to overlay data into the view of the environment based on the user's location. For example, a markerless AR app on a smartphone 400 may identify the physical location and coordinates of the user and then overlay mapping directions, names of nearby attractions, and other types of useful location-centric information onto the view of the environment for the participant to experience.

3. Marker Based AR: Marker-based AR (also referred to as image recognition) may use a visual marker 106 or cue, such as a QR/2D code, to trigger an AR result upon the AR viewing device 400 detecting the marker 106. Some markers may include a distinct but simple pattern (e.g., QR code) that may be distinguished from any real-world objects in the vicinity. Other markers 106 (e.g., natural feature tracking markers (NFTs)) may comprise unique aspects of a real-world item that may be identified by the AR reader 400 and used to trigger the AR overlay. Each marker 106 may be programmed or configured within the system 10 to trigger a specific AR effect. The position, orientation, and registration code of the marker may be read and calculated, and the corresponding AR content and/or information may then be overlaid the marker. For example, a marker may be placed on the wall in a museum such that when it is viewed with an AR viewing device 400, the particular marker may be virtually replaced by a specific painting that may then appear to be actually hanging on the wall in the location of the marker.

4. Projection Based AR: Projection based AR may project artificial light onto real world surfaces and then sense a human interaction (e.g., touch) of that projected light. The AR viewing device 400 may differentiate between an expected (or known) projection and the altered projection caused by the user's interaction. Once an interaction with the projected light may be detected, the AR viewer 400 may trigger an AR event (such as a superimposition-based AR event) or any other type of event that may or may not be AR related (such as the commencement of a live performance). Projection based augmented reality also may utilize laser plasma technology to project three-dimensional interactive holograms into mid-air.

The system 10 may include the ability to create and deploy any or all of the types of augmented reality technologies listed above. It is understood that the system 10 also may include any type of AR technology that may not be listed above but that may be used to provide variations of the visual AR experiences as described herein. It is also understood that the RW object 100 may be implemented with each or any of the AR technologies listed above, or combinations thereof, as well as elements of other types of AR technologies that may not be listed.

In some embodiments, as shown in FIGS. 2 and 3, the RW object 100 includes an article of clothing 102 imprinted with a base graphic 104 and one or more AR markers 106. The article of clothing 102 may include any type of wearable apparel such as (without limitation) shirts, sweatshirts, t-shirts (FIG. 2), vests, long pants, short pants, jackets, coats, as well as any type of apparel accessories such as (without limitation) backpacks, hats (FIG. 3), shoes, ties, handbags, tote bags, aprons, purses, buttons, ribbons, scarfs, other types of items that may be worn and/or carried and any combination thereof.

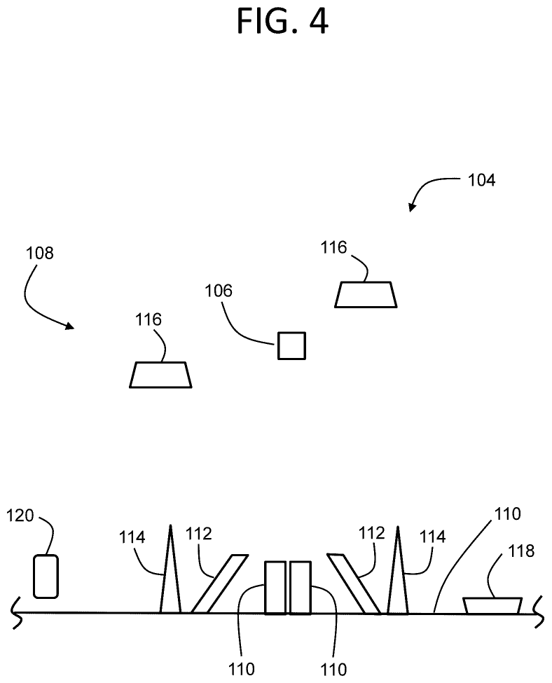

In some embodiments as shown in FIG. 4, the base graphic 104 may include an image of a water fountain display 108. In some embodiments, the graphic 104 also may include one or more embedded AR markers 106, e.g., if implementing marker-based AR.

In some embodiments, the base graphic 104 may comprise or include one or more water fountain plan drawings, photographs, graphical renditions (e.g., photorealistic renderings), illustrations, sketches, drawings, computer generated images, CAD drawings, cartoons, other types of images and any combination thereof. The base graphic 104 may be implemented using one or more colors, in black and white or in any combination thereof.

For example, as shown in FIG. 4, the base graphic 104 may include a plan drawing or other type of depiction of a water display 108 generally illustrating the overall layout of the display 108 and how its various components are arranged in relation to one another. In one example, the plan drawing (and base graphic 104) may depict a real-life display that has been installed and is in operation, e.g., the Fountains of Bellagio in Las Vegas which was created by the inventor.

Alternatively, the base graphic plan drawing 104 may depict a water display that is under development, in which case, the augmented reality application of the current invention may serve as a design tool. For example, preliminary CAD drawings of a project may be implemented with virtual AR elements thereby enabling the designers to experience the performance of the water display during the design phase. In this example, the plan drawing may be augmented and viewed, and then revised by simply moving the location of the water display and corresponding AR markers 106 within the plan. In this way, different virtual versions of the project may be viewed based on different versions of the plan drawing.

In some embodiments, as shown in FIG. 4, the plan drawing base graphic 104 may depict different types of water displays and may include any of the following elements (without limitation):
1. Water delivery devices 110 such as SHOOTER® nozzles, OARSMAN® water delivery devices, water jets, waterfalls, pools of water, foggers, misters, and/or any other type of water delivery devices;
2. Light emitting devices 112 of any color (including white) including submerged devices, exterior devices, broad beam devices, narrow beam devices, spotlights, bulb-based devices, light emitting diodes, fiber optic devices, natural light collecting and/or reflecting devices and/or any other type of lighting devices;
3. Fire delivery devices 114 such as fire shooters, flame emitters, fireworks, and/or any other type of flame delivery devices;
4. Unmanned aerial systems (UASs) 116 that may fly in close proximity to the display (tethered and/or non-tethered) and that generally interact with the display's elements (e.g., provide additional lighting);
5. Unmanned water vehicles 118 (submersible and/or surface vehicles) that may travel within the display (tethered and/or non-tethered) and that generally interact with the display's elements (e.g., provide additional lighting);
6. Speakers 120 to emit audio in orchestration with the water display and its elements (e.g., to provide music that crescendos when the water streams emitted from the fountains 110 are at their highest); and
7. Any other types of elements that may be associated with the water display and/or that may generally interact with the other elements of the water display.

While the foregoing list provides several examples of components and embodiments, the water display depicted in image 108 may include other elements not listed. It is understood that the scope of the system 10 is not limited in any way by the elements that the water fountain image 108 may or may not include.

In some embodiments, the system 10 may implement marker-based AR and may utilize one or more AR markers 106 to trigger the overlay of virtual AR information onto the base graphic 104 via the AR viewing device's display. The AR marker(s) 106 may include any type of adequate visual cue, e.g., barcodes such as a quick response (QR) codes, frame markers, natural feature tracking markers (NFT), other types of AR markers, and any combination thereof.

In some embodiments, some AR markers 106, e.g., QR codes and/or frame markers (or similar), may be added to the base graphic 104 but may not necessarily represent an element of the base graphic 104. For example, a QR code used as a marker 106 may not represent a water delivery device 110, a light emitting device 112, a fire delivery device 114, a UAS 116, an unmanned water vehicle 118, speakers 120 or other elements of the water display 108, and instead, may be distinct visual cues specifically used to trigger the overlay of virtual information onto the graphic 104.

Alternatively, a natural feature tracking (NFT) marker 106 may be implemented within the base graphic 104 as an actual element of the base graphic 104 (e.g., as an element of the water display 108). For example, an NFT marker 106 may include the graphical form and shape of a water delivery device 110. Prior to implementation, the descriptors of the NFT marker 106 (e.g., the device's top corners and/or edges) and their respective locations on the base graphic 104, may be provided to the system 10 and stored in a backend database 206. Then, during the AR experience, the backend's applications 204 may match the descriptors captured by the AR viewing device 400 to those stored in the database 206, and subsequently trigger the desired virtual information to be overlaid onto the water display image 108. For example, recognition of the NFT “water delivery device” marker 106 may trigger the system 10 to overlay fountains emitting streams of water, light shining different colors, etc.

In another example, the system 10 may include a plan drawing of the components comprising the Fountains of Bellagio. With the AR technology and application of the system 10, a viewer may point his/her viewing device 400 at the plan drawing (which serves as the base graphic 104) and recreate a performance by the Fountains of Bellagio. Indeed, many Las Vegas visitors who experience the Fountains of Bellagio in real life may desire the system 10 to recreate that experience later.

The foregoing NFT marker example is meant as an example and any adequate graphical form and/or shape of any sufficient element of the water display image 108 may be utilized as an NFT marker 106. The scope of the system 10 is not limited in any way by the type of NFT marker(s) 106 that may be implemented and/or utilized by the system 10.

In other embodiments, the system 10 may implement markerless AR experiences and the virtual AR information may be triggered by the precise location of the user Un (e.g., as determined by the location application within the AR viewing device 400). Additional examples of this will be described in other sections.

Information regarding each AR marker 106 (e.g., each marker's descriptors, the respective locations of each marker 106 on each base graphic 104, the types of virtual AR content that each marker 106 may be configured or programmed to trigger, etc.) may be stored in the backend's database 206 and used (e.g., by the backend applications 204) to determine what virtual AR information to provide to each device 400 for augmentation. The database 206 also may store the virtual AR information corresponding to each marker 106 that may be downloaded to each respective device 400 to be overlaid on the base graphic(s) 104. Other information such as user registration information also may be stored.

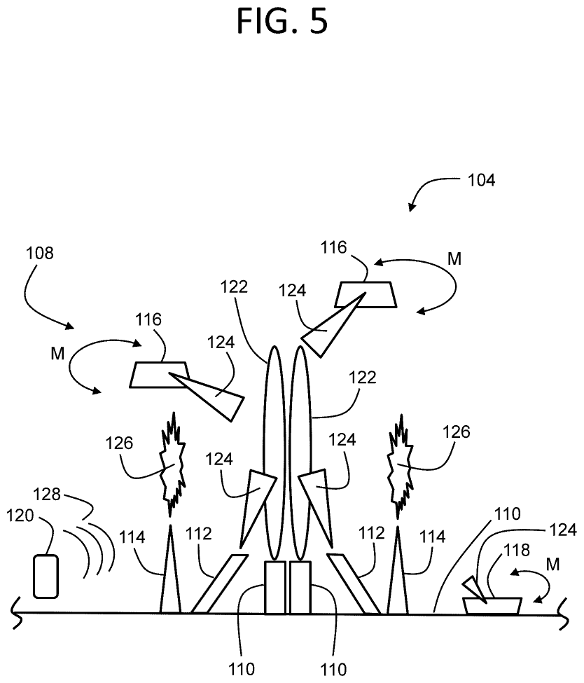

Continuing with the example described in relation to FIG. 4, in some embodiments, as shown in FIG. 5, upon detection and tracking of an AR marker 106 within the base graphic 104, the system 10 may overlay any type of desired virtual AR information onto the article of clothing 102, the plan drawing, etc. In the example of FIG. 5, the virtual AR information may include representations of any type(s) of element(s) that may be associated with a water display such as (without limitation):
1. Water streams 122 emitting from the water delivery devices 110. The water streams 104 may include water blooms, laminar streams, mists, fogs, rain drops, waterfalls, other forms of water such as water pools and any combination thereof;
2. Illumination 124 emitting from the light emitting devices 112, the UASs 116, the unmanned water vehicles 118 and/or from other sources. The illumination 124 may be a combination of any color(s) including white light;
3. Fire 126 emitting from the fire delivery devices 114. The fire 124 may include any type of fire 124 including flames, bursts, fireworks, colored fire, and any other types of fire;
4. Audio 128 that may be presented as being emitted from the speaker 120. The audio 128 may in actuality be emitted from a speaker configured with the AR viewing device 400, and may include music or other sounds orchestrated with the other virtual information (e.g., music orchestrated with the patterns of the water streams 122, the lighting 124, the fire 126, the UASs 116, etc.), sounds of spraying water, sounds of fire bursts, and other types of audio. The audio 128 may be prerecorded and/or live audio 128, or a combination thereof. Live audio 128 may be transmitted from its source in real time to the users' devices 400 and may include narration, audio taken from a live performance (such as the actual water display) or from some other live source of audio or sounds.
5. Movement of the various water display elements. For example, the UASs 116 and/or the unmanned water vehicles 124 may be augmented to travel around in close proximity to the water display 108 while providing illumination to the water streams 122. This is depicted as movement arrows M in FIG. 5. Notably, other elements also may move, for instance, the water delivery devices 122, lighting devices 124 and/or the fire devices 114 may move, change orientation, etc.
6. Other types of information such as text, backgrounds, logos, branding, or other types of additional information. For example, text and/or branding may appear that provides the name and location of the water display 108.

The foregoing examples of augmented virtual information are meant for demonstration and the system 10 may augment other types of virtual information onto or in close proximity to the RW object 100, the article of clothing 102 and/or the base graphic 104. The scope of the system 10 is not limited in any way by the types of virtual information overlaid.

In another embodiment of the invention, the system 10 may detect each AR marker 106 and calculate each marker's relative pose (relative position and/or orientation) with respect to the associated AR viewing device 400. In this way, the system 10 may determine the angle and position at which the base graphic 104 is being viewed by the user and may provide the virtual information overlaid the base graphic 104 as though it too were being seen from that same angle and position. The virtual information may be registered in three-dimensional space with the AR marker 106 so that as the AR viewing device 400 may be moved, the augmented virtual information may remain on the marker 106 and adjusted in real time to continually match the pose of the AR viewing device 400.

In this way, when the user Un may move the AR viewing device 400 relative to the water display image 108 (e.g., by moving relative to the wearer of the article of clothing 102), the virtual information overlaid on the image 108 may be continually adjusted in real time to be seen in the proper perspective to the water display image 108. In one example, a user Un may move his/her AR viewing device 400 with respect to the water display image 108 and be provided an AR experience as though he/she were flying over the water fountain display 108.

In another embodiment of the invention, the system 10 may deliver different virtual AR information to the AR viewing device 400 to overlay the base graphic 104 depending on one or more criterion. For example, in some embodiments, the AR viewing device 400 may sense the ambient lighting of the natural environment (e.g., the natural environment of the user Un and/or the wearer of the article of clothing 102) and provide this information to the backend 200. The backend 200 may then determine what virtual AR information to provide to the AR viewing device 400 based on the ambient lighting information received.

For instance, if the ambient lighting indicates that it may be nighttime, the virtual AR information may include illumination, e.g., bright colored lighting 124, so that the augmented experience reflects a nighttime water display experience. Conversely, if the ambient lighting indicates that it may be daytime, the virtual AR information may include other elements such reflected natural light and/or the flying UASs 116.

In another example, the system 10 may determine the precise location of the user's AR viewing device 400 and may deliver virtual AR information dependent on the location. For instance, if the system 10 determines that the user Un is near a particular water display within a water park, the system 10 may deliver virtual AR information pertinent to the particular water display. In some embodiments, the virtual AR information may be a live feed of captured content from the actual water display (e.g., live video, computer modified video, etc.) so that the virtual AR information may be synchronized in real time with the real-world effects of the water display. Next, as the user Un may move locations to be in close proximity to a different water display within the park, the system 10 may change the delivered virtual AR information to correspond to the new display.

In another example, the system 10 may simply read the code associated with the AR marker 106 and based on the code, deliver the appropriate virtual AR information to the device 400. In this way, different RW objects 100 (e.g., different articles of apparel 102) may be programmed with different markers 106 to provide different sequences of AR effects (different sequences of a water display performances).

The foregoing examples are meant for demonstration and the system 10 may provide any types of different virtual AR information to overlay any base graphic 104 depending on any type(s) of criterion and/or other conditions.

### Development Tool 500

In some embodiments, the system 10 may include a tool 500 for creating base graphics 104 with embedded AR markers 106. The tool 500 may be used by designers of water displays and other types of exhibits to create base graphics 104 with AR markers 106 that represent particular layouts of elements (e.g., water display elements such as water jets, lighting, etc.). The designers may then view visualizations of the layout of elements in action through utilization of the system 10 and an AR viewer 400.

In some embodiments, the system 10 includes a graphical user interface 502 (GUI) implemented on a device 400 or other controller in communication with the backend 200. The tool 500 also may include and/or be configured with a graphics development tool (e.g., a graphics design or editor tool) with which the base graphic 104 may be developed.

In some embodiments, the system 10 may include a library 504 (e.g., stored in the database 206) of unique AR markers 106, with each unique AR marker 160 being associated with a corresponding unique water display element (WDE) and unique virtual AR information (VI).

In some embodiments, the GUI 502 may present visual representations of the available AR markers 106-n and corresponding water display elements WDE-n and virtual AR information VI-n from its library. The tool 500 also may facilitate the drag-and-drop of the markers 106-n into a layout panel 506 to develop the associated base graphic 104. In this way, the designer may simply drag-and-drop a desired AR marker 106-n onto the base graphic 104, adjust its position, orientation, and other parameters, and then view the base graphic 104 through the AR viewing device 400 to see the augmented visualization.

For example, information regarding a first unique AR marker 106-1 may be stored and associated with a first water display element WDE-1 and first unique virtual AR information VI-1. The tool 500 may be used to place the first AR marker 106-1 onto a base graphic 104. Being associated with a unique water display element WDE-1, the marker 106-1 may preferably include an NFT marker in the shape and form of the WDE-1 (e.g., in the shape of a water jet). Then, when an AR reading device 400 is used to detect the first AR marker 106-1 within the base graphic 104, the system 10 may be triggered to download the corresponding first virtual AR information VI-1 from the database 206 to the AR device 400 and to overlay it onto the first water display element WDE-1. In this way, a designer may be presented with an AR visualization that represents the water display element WDE-1 in action.

Expanding on this example, the designer may next place a second AR marker 106-2 into the same base graphic 104 in a particular position and/or orientation with respect to the first AR marker 106-1. By using an AR viewing device 400 to view the combined first and second AR markers 106-1, 106-2, the system 10 may apply the first and second virtual AR information VI-1, VI-2 in the correct positions and/or orientations with respect to one another, and the designer may be presented with an AR visualization of the combined elements WDE-1 and WDE-2 in action together.

This process may continue with the addition and/or removal of AR markers 106-n and corresponding water display elements WDE-n, all the while viewing the composite AR visualizations at each stage of development, until the desired layout of elements is reached. The result may provide an AR-enabled plan drawing of a new water display, an AR-enabled presentation of a proposed water display for a new client, or any other type of AR-enabled representation.

Table I below shows an exemplary list of associated unique AR markers 106-n, unique water display elements WDE-n and unique virtual AR information VI-n. As shown, the marker(s) 106 may represent one or more mechanical components or elements of the water display, such as a nozzle that is programmed to emit water at 50′ or as desired. The AR technology of the system 10 will recognize the nozzle marker and will display the 50′ stream of water virtually.

TABLE I

| AR Marker | Water Display Element | Virtual AR Information |
|---|---|---|
| 160-n | WDE-n | VI-n |
| 106-1 | Nozzle configured to emit | 50′ water stream |
| | a 50′ water stream | |
| 106-2 | Nozzle configured to emit | 100′ water stream |
| | a 100′ water stream | |
| 106-3 | Nozzle configured to emit | Laminar water stream |
| | a laminar stream of water | |
| 106-4 | Bloom Nozzle device | 10′ water bloom |
| 106-5 | Fire Shooter device | 30′ fire burst |
| 106-6 | Flame Emitter device | 10′ flame |
| 106-7 | Spotlight (white) | Beam of white light |
| 106-8 | Red LED Light | Beam of red light |
| 106-9 | Green LED Light | Beam of green light |
| 106-10 | Blue LED Light | Beam of blue light |
| 106-11 | Lighted UAS | Flying UAS w/lights |
| 106-12 | Lighted water vehicle | Moving water vehicle |
| 106-13 | Audio | Orchestrated music |
| 106-14 | Mister | 10′ mist cloud |
| 106-15 | Fogger | 20′ fog cloud |

The items listed in Table I are examples, and the system 10 may include any number and/or types of associated unique AR markers 160-n, unique water display elements WDE-n and unique virtual AR information VI-n. The scope of the system 10 is not limited in any way by the number and/or types of associated unique AR markers 160-n, unique water display elements WDE-n and unique virtual AR information VI-n that the system 10 may include.

Furthermore, the development tool aspect of the invention is not to only water display design. The invention may also be used to develop and/or design other items, e.g., amusement rides, fireworks displays, vehicles and their motion, as well as other applications.

The inventor has constructed displays around the world that provide a number of different visual effects. In addition to the Fountains of Bellagio in Las Vegas, the inventor has created the cauldron for the Olympic flame at the 2002 Winter Olympic Games in Salt Lake City and the Dubai Fountains. While these and other displays are unique unto themselves, they still do use a number of common components, e.g., SHOOTER® water delivery nozzles, LED and other lighting, fire and other components that provide various effects. Furthermore, a particular component may form part of various displays but may be used differently. For example, the same SHOOTER® water delivery nozzle may emit water at 30′ in one display but 80′ in another display.

During the design and development phase of a display, plan drawings, engineering drawings and other types of electronic and paper documentation are created. This documentation typically specifies where the different components of the display are positioned, how they interact and their function in the overall display.

The augmented reality of the system 10 may be used in connection with the design and development phase of the displays. For example, each SHOOTER® water delivery nozzle may be represented in a plan drawing by a certain marker 106 that will be recognized by the augmented reality device 400. Also, if the SHOOTER® water delivery nozzles emit water at different heights, their markers may vary to correspond to the different heights. Furthermore, different markers may be assigned to the various components comprising the display.

In this manner when the augmented reality device 400 with the appropriate software is pointed at the plan drawing, it may recognize the markers 106 of each component and provide a visual display on the device 400 that generally brings the plan drawing to life. For example, when the device 400 is pointed at a particular SHOOTER® water delivery nozzle, the device's screen will show that component emitting water at a specified height.

### Real Time

Those of ordinary skill in the art will realize and understand, upon reading this description, that, as used herein, the term “real time” means near real time or sufficiently real time. It should be appreciated that there are inherent delays in electronic components and in network-based communication (e.g., based on network traffic and distances), and these delays may cause delays in data reaching various components. Inherent delays in the system do not change the real time nature of the data. In some cases, the term “real time data” may refer to data obtained in sufficient time to make the data useful for its intended purpose.

Although the term “real time” may be used here, it should be appreciated that the system 10 is not limited by this term or by how much time is actually taken. In some cases, real-time computation may refer to an online computation, i.e., a computation that produces its answer(s) as data arrive, and generally keeps up with continuously arriving data. The term “online” computation is compared to an “offline” or “batch” computation.

### Synchronous

As used herein, including in the claims, the term “synchronous” (or “synchronously”) with respect to multiple actions, generally means that the actions occur at the same time or at substantially the same time. Similarly, as used herein, including in the claims, the term “simultaneous” (or “simultaneously”) with respect to multiple actions, generally means that the actions occur at the same time or at substantially the same time.

As is known, there are inherent delays in electronic components and in network-based communication. Inherent delays in the system do not change the synchronous nature of actions. In some cases, the term “synchronous” (or “synchronously”) with respect to multiple actions may refer to actions performed in sufficient time to make the actions useful for their intended purpose. For examples, content delivered to multiple devices at substantially the same time is considered to be synchronously delivered.

### Computing

The applications, services, mechanisms, operations, and acts shown and described above are implemented, at least in part, by software running on one or more computers.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

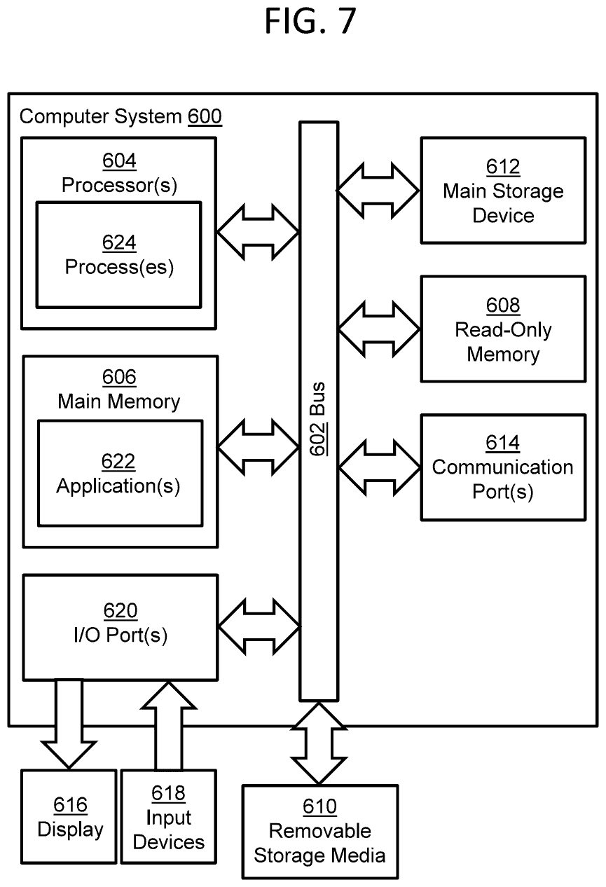

FIG. 7 is a schematic diagram of a computer system 600 upon which embodiments of the present disclosure may be implemented and carried out.

According to the present example, the computer system 600 includes a bus 602 (i.e., interconnect), one or more processors 604, a main memory 606, read-only memory 608, removable storage media 610, mass storage 612, and one or more communications ports 614. Communication port(s) 614 may be connected to one or more networks (not shown) by way of which the computer system 600 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 604 can be any known processor, such as, but not limited to, an Intel® Itanium® or Itanium 2® processor(s), AMD® Opteron® or Athlon MP® processor(s), or Motorola® lines of processors, and the like. Communications port(s) 614 can be any of an Ethernet port, a Gigabit port using copper or fiber, or a USB port, and the like. Communications port(s) 614 may be chosen depending on a network such as a Local Area Network (LAN), a Wide Area Network (WAN), or any network to which the computer system 600 connects. The computer system 600 may be in communication with peripheral devices (e.g., display screen 616, input device(s) 618) via Input/Output (I/O) port 620.

Main memory 606 can be Random Access Memory (RAM), or any other dynamic storage device(s) commonly known in the art. Read-only memory (ROM) 608 can be any static storage device(s) such as Programmable Read-Only Memory (PROM) chips for storing static information such as instructions for processor(s) 604. Mass storage 612 can be used to store information and instructions. For example, hard disk drives, an optical disc, an array of disks such as Redundant Array of Independent Disks (RAID), or any other mass storage devices may be used.

Bus 602 communicatively couples processor(s) 604 with the other memory, storage and communications blocks. Bus 602 can be a PCI/PCI-X, SCSI, a Universal Serial Bus (USB) based system bus (or other) depending on the storage devices used, and the like. Removable storage media 610 can be any kind of external storage, including hard-drives, floppy drives, USB drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device.

Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 606 is preferably encoded with application(s) 622 that support(s) the functionality as discussed herein (the application(s) 622 may be an application(s) that provides some or all of the functionality of the services/mechanisms described herein). Application(s) 622 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 604 accesses main memory 606 via the use of bus 602 in order to launch, run, execute, interpret or otherwise perform the logic instructions of the application(s) 622. Execution of application(s) 622 produces processing functionality of the service related to the application(s). In other words, the process(es) 624 represent one or more portions of the application(s) 622 performing within or upon the processor(s) 604 in the computer system 600.

It should be noted that, in addition to the process(es) 624 that carries (carry) out operations as discussed herein, other embodiments herein include the application 622 itself (i.e., the un-executed or non-performing logic instructions and/or data). The application 622 may be stored on a computer readable medium (e.g., a repository) such as a disk or in an optical medium. According to other embodiments, the application 622 can also be stored in a memory type system such as in firmware, read only memory (ROM), or, as in this example, as executable code within the main memory 606 (e.g., within Random Access Memory or RAM). For example, application(s) 622 may also be stored in removable storage media 610, read-only memory 608, and/or mass storage device 612.

Those skilled in the art will understand that the computer system 700 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used herein, including in the claims, the term “portion” means some or all. So, for example, “A portion of X” may include some of “X” or all of “X”. In the context of a conversation, the term “portion” means some or all of the conversation.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

As used herein, including in the claims, the term “automatic,” with respect to an action, generally means that the action occurs with little or no human control or interaction. The term “automatic” also includes the case of no human control or interaction. Thus, e.g., the term “triggered automatically” means “triggered with little or no human control or interaction,” and includes the case “triggered with no human control or interaction.”

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.”) and the like, is merely intended to better illustrate the invention and does not indicate a limitation on the scope of the invention unless specifically so claimed.

Any acts described in the specification may be performed in any order or simultaneously, unless the context clearly indicates otherwise.

All of the features and/or acts disclosed herein can be combined in any combination, except for combinations where at least some of the features and/or acts are mutually exclusive. In particular, preferred features of the invention are applicable to all aspects of the invention and may be used in any combination.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

Although certain presently preferred embodiments of the invention have been described herein, it will be apparent to those skilled in the art to which the invention pertains that variations and modifications of the described embodiments may be made without departing from the spirit and scope of the invention.

What is claimed is:

1. An augmented reality system comprising:
at least one article of apparel;
at least one graphical image of a water display including one or more water display elements configured with the at least one article of apparel;
at least one AR marker configured with the at least one graphical image;
an image recognition application adapted to recognize the at least one AR marker; and
memory storing at least one virtual information associated with the at least one AR marker;
wherein when the image recognition application recognizes the at least one AR marker, the system augments the at least one graphical image with the at least one virtual information.

2. The system of claim 1 wherein the at least one AR marker includes at least one of the one or more water display elements.

3. The system of claim 2 wherein the at least one virtual information includes at least one virtual image of water streams and wherein the system augments the at least one graphic image such that the at least one virtual image of water streams appears to emanate from the at least one of the one or more water display elements.

4. The system of claim 1 wherein the at least one virtual information includes at least one moving imagery of water streams.

5. The system of claim 1 wherein the one or more water display elements is selected from a group consisting of a water delivery device, a light emitting device, a fire delivery device, an unmanned aerial system, an unmanned water vehicle, and a speaker.

6. The system of claim 1 wherein the at least one article of apparel is selected from a group consisting of a shirt, a hat, a sweatshirt, a vest, long pants, short pants, a jacket, a coat, a backpack, a shoe, a tie, a bag, an apron, a purse, a button, a ribbon, and a scarf.

7. The system of claim 1 further comprising:
a graphical user interface (GUI) adapted to edit a virtual representation of the at least one graphical image and to virtually configure a virtual representation of the at least one AR marker with the virtual representation of the at least one graphical image.

8. The system of claim 7 wherein the GUI includes a library including one or more virtual representations of the at least one AR marker.

9. The system of claim 8 wherein the GUI is adapted to enable a drag and drop of a first one of the one or more virtual representations of the at least one AR marker onto the virtual representation of the at least one graphical image.

10. The system of claim 9 wherein the at least one AR marker includes at least one of the one or more water display elements.

11. A method of creating an image for use with an augmented reality (AR) system comprising:
(A) displaying, on a graphical user interface (GUI), at least one graphical image of a water display including one or more water display elements;
(B) displaying, on the GUI, a library of at least one AR marker; and
(C) enabling, using a computer system, a drag and drop of the at least one AR marker onto the at least one graphical image of a water display.

12. The method of claim 11 wherein the at least one AR marker includes at least one of the one or more water display elements.

13. The method of claim 11 further comprising:
(D) associating, using the computer system, at least one virtual information with the at least one AR marker.

14. The method of claim 13 wherein the at least one virtual information includes at least one moving imagery of water streams.

15. The system of claim 11 wherein the one or more water display elements is selected from a group consisting of a water delivery device, a light emitting device, a fire delivery device, an unmanned aerial system, an unmanned water vehicle, and a speaker.
